(19) United States
(12) Patent Application Publication
(10) Pub. No.: US 2003/0076031 A1
(43) Pub. Date: Apr. 24, 2003

(54) Covering for a display device

(76) Inventors: Jurgen Adams, Villingen-Schwenningen (DE); Hubert Grunebaum, Niedereschach (DE); Jurgen Wolf, Villingen-Schwenningen (DE)

Correspondence Address: Martin A. Farber, Suite 473, 866 United Nations Plaza, New York, NY, 10017, US

(21) Appl. No.: 10/074,682

(22) Filed: Feb. 12, 2002

(30) Foreign Application Priority Data
Feb. 21, 2001 (DE) 101 08 390.4

(51) Int. Cl. H01J 63/04; H01J 1/62

(52) U.S. Cl. 313/493

(57) ABSTRACT

For the covering of a display device,

the covering being translucent, at least in some areas,

the covering at least partly covering the front side of the display device,

the covering shielding electromagnetic fields, it is proposed to configure it in such a way that

a) either the covering is made of an intrinsically electrically conductive polymeric material or contains such a material and the covering has a means of making electrical contact

b) or that a thin, intrinsically electrically conductive polymer layer that is translucent, at least in some areas, is applied to the covering, and the polymer layer has a means of making electrical contact.

The invention relates to a covering for a display device,

the covering being translucent, at least in some areas,

the covering at least partly covering the front side of the display device,

the covering shielding electromagnetic fields.

Coverings of the aforementioned type are needed in automobile engineering for various information systems such as combination instruments or additional navigation displays. For example, in a single housing in addition to at least one analogue display, which nowadays is most often motor-driven, there is an increasing tendency for a combination instrument to also contain display systems whose area becomes greater and greater, such as monitors, liquid crystal displays, light-emitting diode displays, electroluminescent displays and plasma displays, and also control units equipped with computer intelligence together with electrical connecting lines, in order to operate the aforementioned drives and display systems and to permit their communication with other equipment in the vehicle. In the process, higher and higher signal sensitivities and clock frequencies cause increasing problems relating to the outward and inward radiation of electromagnetic fields, for example, the electronic and electromagnetic components built into a combination instrument, such as drives, display systems and control units can disrupt other equipment in the vehicle, such as satellite navigation systems or radio devices—in the worst case even safety-relevant equipment—as a result of the emission of electromagnetic fields, or the aforementioned electronic and electromagnetic components built into the combination instrument can be impaired in terms of their function by means of electromagnetic fields from other emitters.

When it is installed in the vehicle, a display device formed as a combination instrument is at least partly covered on the front side, that is to say on the side facing the driver of the vehicle, by a covering which is translucent and which can be formed as a dial or as a cover glass or cover pane. The scales and displays of a combination instrument can virtually always be illuminated, in order to ensure their legibility even under unfavorable ambient light conditions. In order to illuminate the scales and displays, light-emitting means such as incandescent bulbs or light-emitting diodes are arranged in the housing of the combination instrument, and allow their light to shine through toward the driver, at least in some areas of the covering.

In order to improve the electromagnetic compatibility of generic display devices, attempts have been made to shield individual components such as drives, control units and connecting lines by means of sheet-metal constructions or conductive encapsulations. However, measures of this type are complicated and often oppose the stipulation to construct generic display devices to be as flat as possible. In addition, other commercially available shielding materials such as electrically conductive gauze fabric or woven fabrics made of fine metal wires have the disadvantage of, firstly, being very expensive and, secondly having only inadequate abrasion resistance and durability, in particular when bent and curved, although this cannot be taken for granted precisely in the case of cover glasses for combination instruments, which are often not of planar form. At the very least, however, the aforementioned materials therefore do not satisfy the requirements for the display devices under discussion in order to be used for their coverings, since their optical properties such as their transparency and their influence on the design of the covering, which is almost impossible to retouch, are not satisfactory.

The object of the invention is therefore to configure the covering for a display device

the covering being translucent, at least in some areas,

the covering at least partly covering the front side of the display device.

the covering shielding electromagnetic fields, in such a way that a cost-effective flat design of a generic display device is possible, the covering having both permanently good machanical use properties and, primarily, good optical properties and, in spite of its relatively large-area configuration, being capable of shielding electromagnetic fields over its entire area.

This object is achieved by a covering having the features of the equally important claims 1 and 2. The claims which depend on these show further refinements and developments of the solution found.

Therefore, a covering for a display device is proposed in which

a) either the covering is made of an intrinsically electrically conductive polymeric material or contains such a material and the covering has a means of making electrical contact

b) or, alternatively, a covering to which a thin, intrinsically electrically conductive polymer layer that is translucent, at least in some areas, is applied, and electrical contact then being made with the polymer layer.

The invention is now to be explained in more detail using two figures on the example of a covering developed as a dial for a combination instrument.

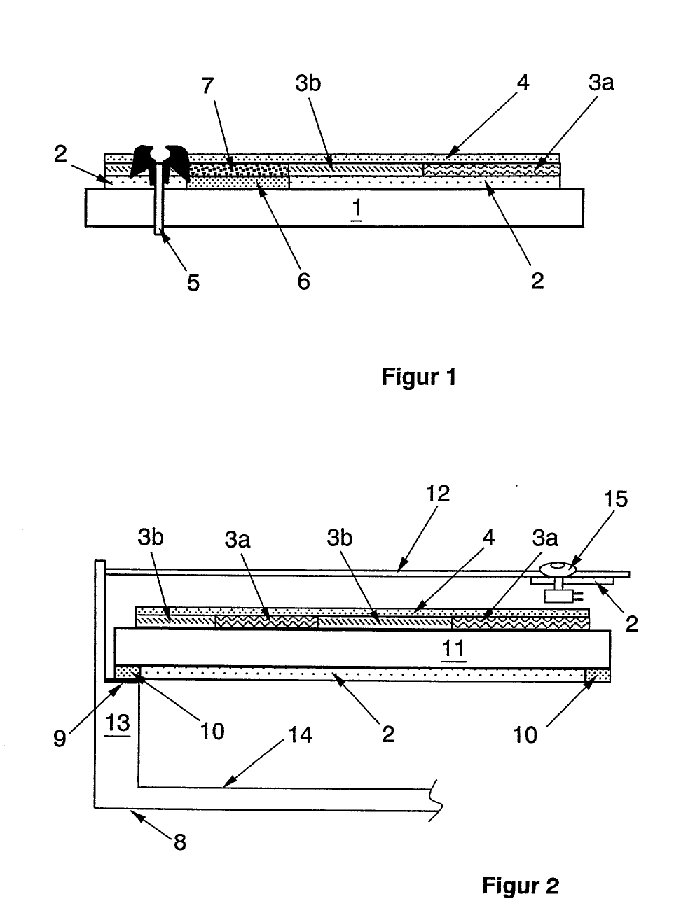

As FIG. 1 shows, a dial of this type essentially comprises

a) a printing substrate or layer substrate 1 which is translucent, at least in some areas,

b) at least one intrinsically electrically conductive polymer layer 2 proposed by the invention,

c) one or more colored layers 3a and 3b,

d) a top layer 4

e) and a means of making contact 5, serving for grounding.

Further polymer layers 6, which differ from the first polymer layer 2 in terms of their electrical conductivity, and associated covering layers 7 can be added as required.

The printing substrate or layer substrate 1 can be made of a plastic board or a flexible film, if the covering of the display device is not formed as a dial, as in the case selected here, but for example as a cover glass protecting a combination instrument at the front side against mechanical influences, the layer substrate 1 can also be made of a mineral material, for example glass. In the case of a plastic board, its plastic material, which can be made of polycarbonate, for example, is generally mixed with white scattering elements, pigments as they are known. One exemplary embodiment of such a printing substrate is a Makrofol substrate, which is used in conjunction with screen printing techniques. Then, according to the invention, in order to achieve a shielding action against electromagnetic fields, the plastic board can be provided, partly or over its entire area, with an electrically conductive polymer layer 2. Flat coatings can be produced economically by means of dip coating or spray coating. Partial coatings may better be applied to the printing substrate by means of screen-printing processes. All the aforementioned coating processes permit many degrees of freedom in the graphic styling of the covering—here on the dial—which is also necessary in the application mentioned, in order to adapt the appearance of the combination instrument to the individual customer wishes.

The polymer layer 2 applied to the printing substrate or layer substrate 1 performs the necessary dissipation of the charges induced by electromagnetic fields. The polymer layer 2 is a conjugated polymer, as it is known, with the property that its conductivity arises without the addition of conductive, inorganic materials, merely on account of a mesoscopic behavior, for which reason one speaks here of an intrinsic electrical conductivity. Polymers with this property are, for example, polyacetylene, polypyrrol, polythiophen and polyaniline.

Although these polymers, as substances, generally have a coloration, they are partly or completely transparent in the case of layer thicknesses in the micrometer range, so that it is possible to implement dials coated with these substances which can be illuminated by the reflected light or transmitted light process.

If, for example, polyaniline is applied as a dispersion at a layer thickness of 0.4-10 μm to a printing substrate made of polycarbonate, using the screen-printing, dip or spraying process, conductivities of 0.5 S/m² can be achieved. It is also possible to produce coatings with polymers which have a conductivity of 100 S/m² in order to use these layers in conjunction with an electrical circuit arrangement for conductor tracks that carry current. This option is intended to be indicated in FIG. 1 by the polymer layer 6. For insulation purposes, such polymer layers 6 with a very high electrical conductivity will be covered with a suitable covering layer 7.

As a rule, a dial is given further applications for its color styling. These can be one or more colored layers 3a and 3b. A colored layer is made firstly of a binder which, in order to adapt its density to the coating process has added to it a solvent based on water or alcohol. The binder encapsulates color-imparting pigments and bonds the pigments to the printing substrate 1. In the present case here, the colored layers 3a and 3b are matched to the calorimetric conditions of the intrinsically electrically conductive polymer layer 2. For example, polyaniline has a greenish basic coloring, for which reason all the colored layers which are applied to a polymer layer 2 of polyaniline have to be matched to the greenish polymer layer 2 by means of additive and subtractive color mixing. The solvent is configured in such a way that it changes the polymer layer 2 only to such an extent that adhesion is produced between the pigments of the colored layer 3a and 3b and the polymer layer 2. In order to impart an adequate transparency or covering power and adhesive force to the polymer layer 2 and the colored layers 3a and 3b on the printing substrate 1, the layer thicknesses are preferably 3 to 12 μm in each case.

A top layer 4 encapsulates all the layers involved in the layer structure, together with the printing substrate 1, against damaging environmental influences, such as the influence of moisture. The selection of the material for this top layer 4 and its processing method influence the external appearance of the dial to a considerable extent. Properties such as gloss, adhesive strength and scratch resistance are set by this top layer 4. A material that is optimal for the top layer 4 is a clear lacquer that can be cured by UV light and which is applied by the screen printing process. In this case, the surface structure of the lacquer and therefore its reflective properties can be set by means of the mixture ratio of various UV-light sensitive lacquer components and by controlling the input of UV-light, since these parameters influence the degree of crosslinking of the monomers contained in the clear lacquer with the polymers. The thickness of the top layer 4 can quite possibly also be more than 12 μm, since it is transparent. Its transparency is far above 80%, even in the case of relatively high layer thicknesses.

In order to achieve a shielding effect against electromagnetic fields, an electrically conductive coating always needs a means of making contact in order to ground this coating. In this case, a shielding acts better the more contact points it has. Making contact with the intrinsically electrically conductive polymer layer 2 can be carried out directly or indirectly. In FIG. 1, the making of direct contact is illustrated as an example. Alternative measures for making contact are formed, for example, by pressing the conductive polymer layer 2 onto or into a metalized contact area on the printing substrate 1, a cutting and pressing connection with the housing of the display device, that is to say the combination instrument here, making a screw contact by means of a star washer under a screw head, or a clamping contact, in which, for example, a U-shaped sheet-metal clamp bears freely on the polymer layer 2.

FIG. 1 shows, as an exemplary embodiment for a means of making contact 5, a riveted cutting connection. In this case, a single metal rivet pierces all the layers during the riveting operation and, at the interfaces to the conductive polymer layer 6, produces a conductive connection. The polymer layer 6 with its high conductivity is in turn again electrically connected to the polymer layer 2. In this way, electric charges can be dissipated for example via an electric line which is fixed to the rivet but which is not illustrated in FIG. 1.

For some embodiments of display devices, it is desirable to shield them completely against electromagnetic fields. By using a dial or cover glass provided with a conductive polymer layer 2, a combination instrument that is sealed against high frequencies, that is to say shielded completely against electromagnetic fields, can be implemented. This is because, as FIG. 2 shows, the load bearing housing of the combination instrument comprises a trough-like element base 8, which contains the electronic and electromechanical components of the combination instrument and, on the front side, carries the dial 11 and, as a rule, a cover glass or a cover pane 12. The element base 8 has an internal circumferential web 13 in order to hold the dial 11, the upper surface 9 of the internal web 13 being provided all around with a commercially available electrically conductive layer or likewise with an intrinsically conductive polymer layer. Likewise, on its underside 10, the dial 11 is provided all around with an intrinsically conductive polymer layer 2. When the dial 11 and element base 8 are assembled, as a result of the two components resting on one another with a form fit, the result is a circumferential contact path and therefore complete shielding of the combination instrument. It is therefore advantageous to form the means of making contact as an electrical connection which at least partly borders the covering, the edge of the covering at least partially resting with a form fit on a component that holds the covering. If complete shielding of the display device or the combination instrument against electromagnetic fields is required, the complete inner side 14 of the element base 8 is provided with an intrinsically conductive polymer layer or a commercially available electrically conductive layer.

In addition to the multilayer construction previously described for a dial that is translucent, at least in some areas and shields against electromagnetic fields, there are still various other applications for the solution according to the invention. For example, optically simpler, single-color displays for example STN displays, are also used in display devices. Simple, single-color diffuser disks often suffice for covering here. In these embodiments, which manage without a plurality of special colored layers and without a top layer, use is made of coverings which intrinsically bear the intrinsically conductive polymer layer or be made of such a material. In such a case, the plastic material from which the covering is to be produced has added to it during the production precisely the amount of the conductive polymer of that grain or particle size which produces the necessary conductivity of 0.5 S/m², for example, and achieves the necessary filter function, that is to say optical attenuation, for example a transparency of 70%, a reflection of 26% and an absorption of 4%.

One development of the invention can also comprise incorporating in the display device at least one momentary-contact push button 15 which switches an electric circuit, in such a way that the momentary-contact push button 15 is arranged in the covering and the area of the momentary-contact push button 15 is likewise shielded against electromagnetic fields by a grounded intrinsically conductive polymer layer 2 applied to the covering or incorporated in the latter, as indicated in FIG. 2. Applications result, for example, in the case of a keyboard panel with a film keyboard which can be illuminated or in the case of a console which contains operating elements and displays, in order to shield devices of all types containing electronic and electromagnetic components against electromagnetic fields, on the operating side or completely.

1. A covering for a display device,
1.1. the covering being translucent, at least in some areas,
1.2. the covering at least partly covering the front side of the display device,
1.3. the covering shielding electromagnetic fields characterized by the fact
1.4. that the covering is made of an intrinsically electrically conductive polymeric material or contains such a material and
1.5. that the covering has a means of making electrical contact.

2. A covering for a display device,
2.1. the covering being translucent at least in some areas,
2.2. the covering at least partly covering the front side of the display device,
2.3. the covering shielding electromagnetic fields characterized by the fact
2.4. that a thin, intrinsically electrically conductive polymer layer that is translucent, at least in some areas, is applied to the covering, and
2.5. that the polymer layer has a means of making electrical contact.

3. The covering for a display device as claimed in one of the preceding claims, characterized by the fact that the means of making contact is formed as a riveted cutting connection.

4. The covering for a display device as claimed in one of the preceding claims, characterized by the fact that the means of making contact is formed as an electrical connection which at least partly borders the covering, the edge of the covering at least partly resting with a form fit on a component that holds the covering.

5. The covering for a display device as claimed in one of the preceding claims, characterized by the fact that the covering is formed as a dial (11) or cover glass (12).

6. The covering for a display device as claimed in one of the preceding claims, characterized by the fact that the display device is formed as a combination instrument.
